(19) United States
(12) Patent Application Publication
(10) Pub. No.: US 2005/0249985 A1
(43) Pub. Date: Nov. 10, 2005

(54) Hybrid power source

(75) Inventors: Jens Muller, Munchen (DE); Kurt Rothkoof, Munchen (DE); Christoph Sonntag, Vaterstetten (DE); Christian Bohm, Siegertsbrunn (DE); Peter Rabenseifner, Olching (DE)

Correspondence Address: IP STRATEGIES, 12 1/2 WALL STREET, SUITE I, ASHEVILLE, NC, 28801, US

(73) Assignee: SFC Smart Fuel Cell AG, Brunnthal-Nord (DE)

(21) Appl. No.: 10/518,440

(22) PCT Filed: Jun. 13, 2003
(86) PCT No.: PCT/EP03/06263

§ 371 Date: Jul. 1, 2005

(30) Foreign Application Priority Data
Jun. 17, 2002 (EP) 02013266.8

(51) Int. Cl. H01M 16/00; H01M 8/04

(52) U.S. Cl. 429/9; 429/7; 429/23

(57) ABSTRACT

The present invention relates to a hybrid energy source (current/voltage source), wherein a fuel cell device and an energy storing device, e.g. a battery and/or a capacitor, are directly interconnected in parallel.

### FIELD OF THE INVENTION

The invention relates to a hybrid energy source (current/voltage source) in which a fuel cell device and an energy storing device, e.g. a battery and/or a capacitor, are interconnected in parallel.

### THE PRIOR ART

Whereas the use of fuel cells to supply energy was normally restricted in the past to exotic applications like space exploration, the rapid technical development of the last few years has resulted in ever increasing applications for fuel cells, in particular as an alternative to batteries in supplying energy by means other than the mains.

When using fuel cells as an alternative energy source to batteries, some principal differences must be considered (the term “batteries” encompasses primary elements and secondary elements, i.e. rechargeable accumulators; in most of the application-oriented examples discussed later, the focus is mainly on the latter):

The capability of fuel cells generally depends to a great degree on the temperature. DMFC systems have their optimal operating point at approx. 60 to 120° C., depending on the design of the system. Unaided, e.g. without a supporting battery, they therefore have only limited cold-start capability. Furthermore, fuel cells are often too unresponsive to cope with sudden major load changes such as may e.g. be caused by switch-on events. In addition, the terminal voltages of fuel cells are strongly load-dependent, while most applications require a constant supply voltage.

Batteries store chemical energy and can therefore be exhausted, while fuel cells do not store energy but simply convert the chemical energy contained in the supplied materials. For the same dimensioning of a fuel cell system (including stored fuel) and a battery, the (in general) substantially longer operational lifetime of the fuel cell counts in its favour.

Through the use of fuel cartridges which can be replaced with just a few simple manual operations, or by supplying fuel continuously from an external fuel tank, it is also possible to provide mains-independent (quasi-)unlimited operation, which cannot be achieved with batteries. Apart from their almost instantaneous response behaviour, another important advantage of batteries is that their terminal voltage is considerably less load dependent than that of comparable fuel cells, as a result of which batteries can handle larger abrupt load changes much quicker and better than fuel cells.

To exploit simultaneously the advantages, partly complementary, of fuel cells and batteries which have been described above, combinations of fuel cells and batteries have been developed which are known as hybrid energy sources or hybrid systems.

Such systems are adapted to the respective field of application. If, for example, the energy requirement can be divided into a normal load component and a peak component, the hybrid system for covering this energy requirement can be so designed that the fuel cell alone satisfies the current consumption of connected consumers in normal load operation, whereas the battery plays a supporting or even a dominant role in the case of load peaks. Depending on the charged status of the battery, this can, in normal load operation (and lower energy requirement), either contribute to meeting the current consumption or it may be charged up by the fuel cell.

However, since the terminal voltages of fuel cells and batteries differ in the degree of their load dependence, and will in general be different as a result, a voltage converter (DC/DC converter) is provided to couple the battery to the fuel cell so as to achieve better matching of the different voltage levels.

This indirect coupling entails various disadvantages, e.g. the additional purchase price of the voltage converter, but also losses associated with the operation of the voltage converter, which have a negative effect on the overall efficiency of the system. To compensate for the losses the fuel cell device must be overdimensioned, entailing further costs and an increase in the space required.

### DESCRIPTION OF THE PRESENT INVENTION

It is an object of the present invention to provide hybrid energy sources comprising a fuel cell device and an energy storing device which avoid the disadvantages occurring with traditional hybrid arrangements and which, in particular, exhibit an improved overall efficiency.

This object is achieved by the hybrid energy source according to the present invention in accordance with claim 1. Advantageous further developments and detailed solutions are cited in the subclaims.

The hybrid arrangement according to the present invention comprises a fuel cell device and an energy storing device which are directly interconnected in parallel.

In contrast to the indirect coupling of fuel cells to rechargeable batteries via a voltage converter which is subject to loss, known technology, the voltage taps of the fuel cell device and the energy storing device in the present invention are interconnected directly, i.e. without a voltage converter, in a parallel circuit. Due to this parallel circuit the voltage taps of the fuel cell device and the energy storing device are at the same potential, corresponding to the terminal potential of the hybrid energy source, in a stationary state (time-constant currents).

If in the currentless state the output voltage (source voltage or open-circuit voltage) of the fuel cell device is greater than that of the energy storing device, there is in open-circuit operation (i.e. no external consumer) of the hybrid arrangement a current flow within the parallel circuit via which the energy storing device will be charged up all the time there is a difference in the source voltages. If a consumer is connected, it depends on the actual load and the actual charged status of the energy storing device whether this contributes to the current requirement of the consumer and is thereby discharged, or whether the current requirement of the consumer is met by the fuel cell device alone, the energy storing device possibly being charged up simultaneously.

The coupling according to the present invention without a voltage converter which is subject to loss being connected between the fuel cell device and the energy storing device increases the efficiency and makes possible a reduction in the purchase price and in the space needed.

In a preferred further development the energy storing device comprises a capacitor. This is charged up by the fuel cell device until it reaches the terminal potential. While the load current remains constant over time the capacitor remains in the charged state, i.e. is passive. The load current is supplied exclusively by the fuel cell device (and, if present, further energy storing devices). If the load current requirement increases, however, so that there is a drop in the terminal voltage, the capacitor will contribute to the load current until it finds itself at the lowered terminal potential. Conversely, if the load current decreases, the capacitor will be charged up again due to the increase in the terminal potential of the fuel cell device. The advantage of this arrangement is that load increases, and in particular abrupt load peaks, for which the fuel cell device is too sluggish to supply the necessary current (and for which an additionally provided battery might also be too slow), can be accommodated with a suitably chosen capacitor.

In a particularly preferred alternative or additional further development of the hybrid energy source the energy storing device comprises a battery which is connected to the fuel cell device in a homopolar arrangement.

Other than in the prior art described at the outset, according to which the battery of a fuel cell/battery hybrid arrangement is charged up by the fuel cell device via an interposed voltage converter and where the terminal voltages of the battery and of the fuel cell device are generally different even in the stationary state (i.e. for vanishing or constant load current), no voltage converter is provided in the present invention: the terminal voltage of the hybrid energy source therefore depends critically on the internal resistance of the battery and of the fuel cell device and on their source voltages and lies between these two source voltages. The source voltage difference between the battery and the fuel cell device is the concrete driving force for charging the battery.

In an further development of the cited hybrid energy source which is advantageous under certain conditions at least one of the homopolar connections between the fuel cell device and the battery has two branches, the first branch being provided for the charging of the battery by the fuel cell device and having a charge limiter to limit the charging and the second branch being connected to an output terminal and containing a device to prevent charging of the battery via the second branch.

This further development is particularly advantageous when the source voltage of the fuel cell device is markedly higher than the maximum source voltage of the battery: in this case overcharging of the already fully charged battery might occur without the charge limiter.

If the services of the battery are required over an extended period it may become discharged to such a degree that it ends up in a charged status with very low source voltage. If there is a considerable drop in the load current in this situation, there is the danger that, because of the great difference in the source voltages of the fuel cell and the battery, a very high, possibly destructive charging current might flow. This, too, can be avoided according to the further development described above.

In another preferred further development the hybrid energy source includes a device to prevent an electrolysis current through the fuel cell device.

This device might be e.g. a diode which blocks when the source voltage of the fuel cell device falls below that of the battery. This can occur e.g. under abnormal operating conditions of the fuel cell device, such as lack of fuel and/or oxygen, but also when the load current “extracted” by the consumer is so large that the voltage of the fuel cell device completely or partially collapses.

An important consideration in the design of the hybrid energy source with a fuel cell device and a battery is the choice of the respective source voltages. Ignoring normal operational fluctuations, the source voltage of the fuel cell device can be regarded as constant. The source voltage of the battery, on the other hand, depends on its charged status. The maximum source voltage is attained when the battery is fully charged. Normally it only makes sense to use a battery when the maximum charged status is at least approximately reached. For this reason the source voltage of the battery in its fully charged state should not differ too much from the source voltage of the fuel cell device. If it is markedly higher, the battery can only be inadequately charged. If it is markedly lower, measures must be taken to prevent the battery being overcharged.

To avoid this problem, the hybrid energy source is preferably so implemented that the source voltage of the battery in the fully charged state deviates by less than 10% from the source voltage of the fuel cell device.

A battery with an internal resistance which is markedly smaller than that of a fuel cell device imposes its voltage on the fuel cell device and on the whole hybrid energy source. This means, however, that the terminal voltage of the hybrid energy source depends very strongly on the charged status of the battery. Many consumers require a constant supply voltage, however.

In order to provide a constant output voltage U_{A} which, in particular, is independent of the charged status of the battery, instead of a fluctuating terminal voltage U_{K}, an advantageous further development is provided wherein the hybrid energy source includes a voltage regulator which converts the terminal voltage U_{K} of the hybrid energy source into the desired output voltage U_{A}. Such a voltage regulator may be a linear regulator, a voltage converter or a Zener diode or it may comprise these elements. Since it is desirable to avoid all dissipative processes so as to achieve the highest possible efficiency of the hybrid energy source, the voltage regulator in a particularly preferred further development comprises a PWM voltage regulator, the losses of which are mainly confined solely to switching events.

To control the PWM voltage regulator the terminal voltage and/or the charged status are measured continuously or at short intervals (e.g. via shunts) and the setting values of the PWM voltage regulator are adjusted appropriately in response to changes. This adjustment of the PWM voltage regulator in response to changes in the terminal voltage can take place almost instantaneously since the electronic switching times are negligible.

The present invention is described below making reference to the enclosed drawings, which elucidate the basic principles of the present invention and also present preferred embodiments thereof.

FIG. 1 shows schematically the dependence of the terminal voltage of a fuel cell on the load current;

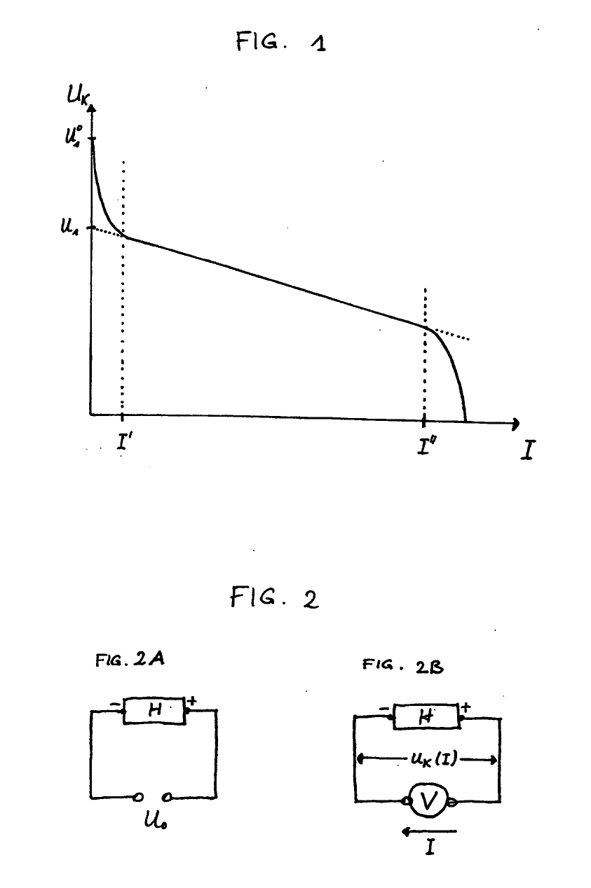

FIG. 2 shows a schematic circuit diagram of the hybrid energy source with definitions of terms used in the description;

FIG. 3 shows the principle of the hybrid energy source according to the present invention with a fuel cell device and an energy storing device;

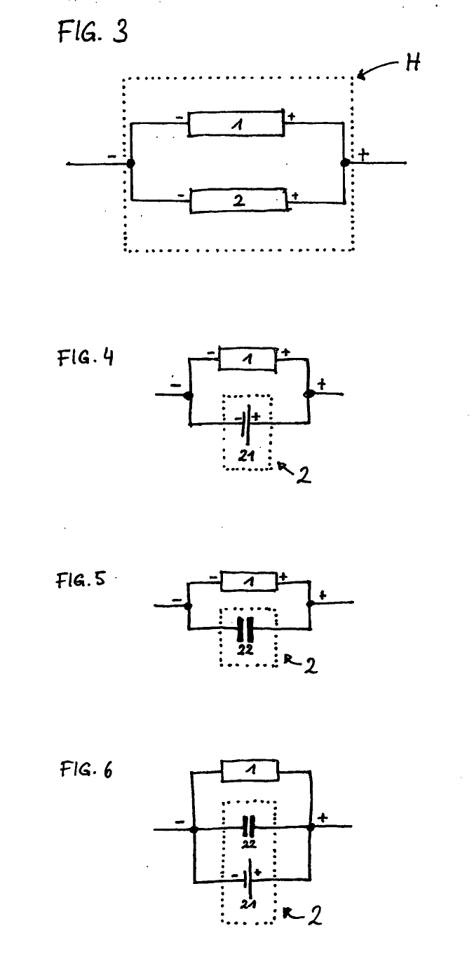

FIG. 4 shows a first preferred embodiment of the hybrid energy source of FIG. 3, wherein the energy storing device is a battery.

FIG. 5 shows a second preferred embodiment of the hybrid energy source of FIG. 3, wherein the energy storing device is a capacitor;

FIG. 6 shows a third preferred embodiment of the hybrid, energy source of FIG. 3, wherein the energy storing device is implemented by a battery and a capacitor connected in parallel;

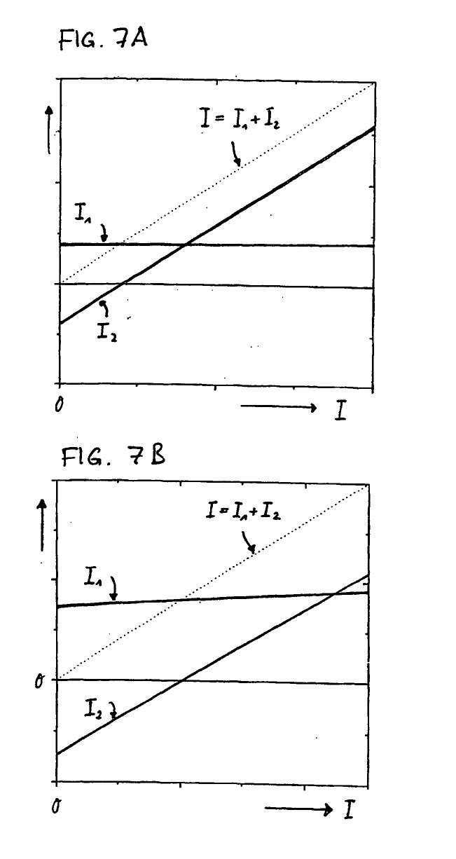

FIG. 7 shows the changes in the partial currents as a function of the load current depending on the charged status of the battery for the embodiment of FIG. 4;

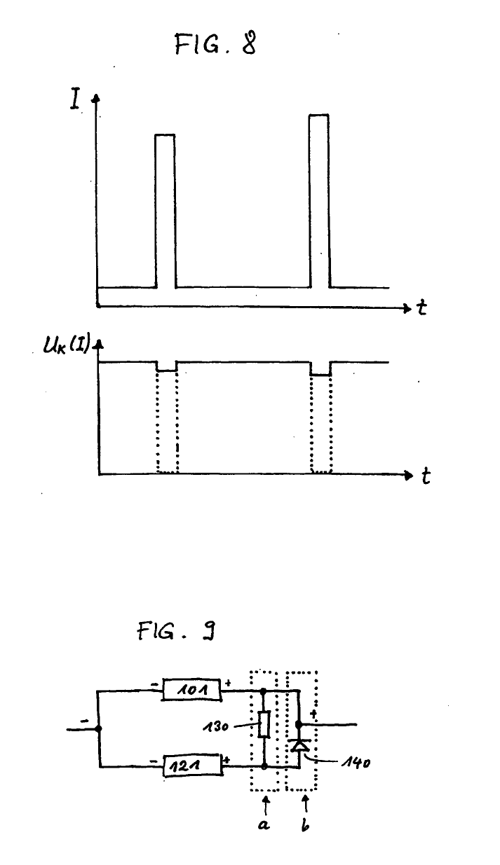

FIG. 8 shows the effect of load peaks on the terminal voltages of a fuel cell (dotted lines) and of a hybrid energy source (continuous line) according to the embodiments of FIG. 5 and FIG. 6;

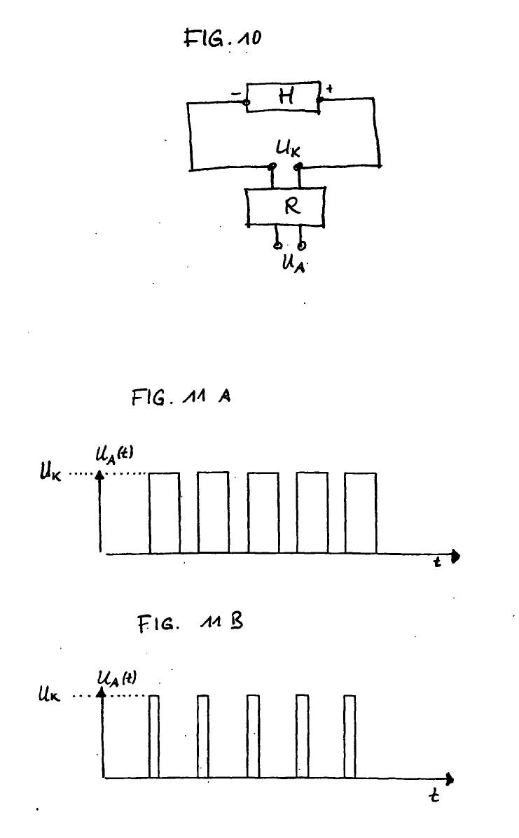

FIG. 9 shows a further development of the hybrid energy source according to the present invention of FIG. 3;

FIG. 10 shows a further development of the hybrid energy source of FIG. 2 for providing an output voltage differing from the terminal voltage;

FIG. 11 shows a preferred method for providing any desired output voltage.

FIG. 1 is meant to show in exemplary fashion the U_{K}(I) characteristic of a fuel cell. The U_{K}(I) diagram can be divided into three regions: I<I′, I′≦I≦I″, and I>I″.

At low currents (I<I′) the charge transfer overvoltage attributable to catalytic losses dominates. At high currents (I>I″) the diffusion overvoltage dominates. Both effects are strongly non-linear and lead to a very rapid decrease in the terminal voltage U_{K} with increasing load current.

Between these two extremes there is in the U_{K}(I) diagram the region I′≦I≦I″ which is dominated by the internal resistance R₁ and within which the dependence is substantially linear and which in general represents the region of the U_{K}(I) diagram which is relevant for fuel cell applications. For this region the following equation holds true to a good approximation:
i U_{K}(I)=U₁−R₁I,
where it should be borne in mind that the voltage U₁ defined by this equation is smaller than the true source voltage (open-circuit voltage) of the fuel cell due to charge transfer at low currents. Ignoring this, and guided by the behaviour of batteries, whose U_{K}(I) curve is described by an analogous equation, U₁ will be described hereafter, somewhat simplistically, as the (reduced) source voltage. The open-circuit voltage, i.e. the true source voltage, will be distinguished by an index “o” (as a subscript or, if there are several indices, as a superscript): U^{o}₁.

The FIGS. 2A and 2B serve to define the terms used in the present application as well as to elucidate the basic principle on which the present invention is based.

In FIG. 2A the reference letter H designates a hybrid energy source with terminals between the voltage taps of which in open-circuit operation, i.e. without external consumer, there is a voltage drop equal to the terminal voltage U_{K}(0)=Uₒ (open-circuit voltage).

In the present invention the hybrid energy source H is realized by connecting a fuel cell device 1 and an energy storing device 2 in parallel. It is sketched in FIG. 3. Although the fuel cell device 1 and the energy storing device 2 can have different source voltages U₁ and U₂, they are interconnected directly (i.e. without voltage converter) without voltage matching. The terminal voltage U_{K}(0) generally lies between U₁ and U₂, but it depends in detail on the electrical parameters of the fuel cell device 1 and of the energy storing device 2.

As described below in exemplary fashion making reference to preferred embodiments, the energy storing device 2 may be a battery (accumulator) or a capacitor, but also an arrangement of a number of batteries or capacitors and also a combination of battery(ies) and capacitor(s).

FIG. 2B shows the hybrid energy source H supplying a consumer V, which is drawing a load current I, thereby lowering the terminal voltage to a value U_{K}(I)<Uₒ. If, instead of the hybrid source, a fuel cell alone is used as the energy source (current/voltage source), this lowering of the terminal voltage in load operation can lead to intolerable voltage losses due to the strong load dependence of fuel cells. This behaviour of fuel cells, which is disadvantageous for many applications, is meant to be mitigated or eliminated in a simple and elegant way by the present invention.

FIG. 4 shows the realization of the hybrid energy source by a combination of a fuel cell device 1 and a battery 21.

First, open-circuit operation will be considered: without external current flow (consumer switched off), the voltage dropped across the voltage taps of the hybrid energy source H is the open-circuit voltage U_{K}(0), which is determined by the source voltages U₁, U₂ and the internal resistances R₁, R₂ of the two energy sources:
U_{K}(0)=(U₁R₂+U₂R₁)/(R₁+R₂).

For the usual situation where the internal resistance R₁ of the fuel cell 1 is considerably higher than the internal resistance R₂ of the battery 21, R₁>>R₂, this simplifies to:
U_{K}(0)≈U₂.

The open-circuit voltage U_{K}(0) is thus mainly determined by the source voltage U₂ of the battery 21 and therefore depends on the actual charged status of the battery 21. Since the battery is charged up by the fuel cell, the maximum source voltage of the battery is, at the same time, limited by the source voltage of the fuel cell.

It can easily be shown that for R₁>>R₂ the terminal voltage U_{K}(I)(≈U₂−R₂I₂≈U_{K2}(I)) of the hybrid energy source H is determined by the battery 21 even for non-vanishing load currents.

In this hybrid energy source H the terminal voltage of the battery 21 is imposed on the fuel cell 1, i.e. the fuel cell 1 is operated “voltage controlled”.

In open-circuit operation, i.e. when no load current flows (I=0), a current, which can be used to charge up the battery, flows within the hybrid source when the source voltages are unequal U₁≠U₂. In this case:
0=I₁+I₂
or
I₁=−I₂.

The technical current direction used in electrical engineering has been adopted here for determining the sign, i.e. a current which is provided by the energy source (current source) concerned has a positive sign whereas a current which is fed into the energy source has a negative sign.

Since a fuel cell—like a primary element—can be destroyed by an electrolysis current (current contrary to the natural current direction), the condition I₁≧0 should always hold true, which with the use of batteries and fuel cells in the arrangement sketched in FIG. 3 is only realizable without the use of additional electronic components if
U₁≧U₂.

As an alternative, or additionally as a precautionary measure, a diode can be so provided in series with the fuel cell and the energy storing device that only I₁≧0 is allowed. For U₁<U₂ this is indeed necessary.

The condition U₁≧U₂ is also the requirement that must be fulfilled so that the fuel cell can be used to charge up the battery in open-circuit or partial-load operation.

If the hybrid energy source is used to supply an external consumer which draws the load current I from the hybrid source, this load current I is given by the sum of the partial currents I₁ and I₂ of the two energy sources 1 and 21:
I=I₁+I₂.

The source voltage U₂ and the internal resistance R₂ of the battery depend on its charged status: as the battery discharges the source voltage U₂ falls, whereas the internal resistance rises. The current dependence of the internal resistance R₂ can, on the other hand, be considered to be negligible to a good approximation over a wide range, so that a linear relationship can be assumed for the U_{K}(I) characteristics:
U_{K}(I)=U₂−R₂I.

As has already been indicated with reference to FIG. 1, the U_{K}(I) characteristic of a fuel cell is considerably more complex and more strongly load dependent than that of a battery. Here also, though, there is a region which can be described by an equivalent equation:
U_{K}(I)=U₁−R₁I.

In the following analysis only this region will be considered.

The influence that a change in the charged status has on the system properties is illustrated semi-quantitatively in FIGS. 7A and 7B on the basis of model assumptions. In the diagrams the dependence of the partial currents I₁, I₂ on the total current I=I₁+I₂ is shown for two different charged statuses of the battery.

An approximation in this model is that the exponential rise of the voltage of the fuel cell at very low currents is ignored (cf. FIG. 1) and the linear region is extrapolated down to I→0.

In FIG. 7A the battery has a higher charged status than in FIG. 7B and the source voltage difference U₁−U₂ for the lower charged status of the battery is taken to be twice as high as for the higher charged status. Furthermore, the internal resistance ratio R₂/R₁=1/100 has been chosen for the higher charged status and the internal resistance ratio R₂/R₁=1/10 for the lower charged status. It is evident that these numerical values have been chosen at random and serve only to clarify the situation underlying this preferred embodiment.

It should be noted that the reduced source voltage U, of the fuel cell has here been assumed to be higher than the charged-status-dependent source voltages U₂ of the battery. The statements made are, however, also qualitatively correct when these source voltages U₂ are in fact higher than the (reduced) source voltage U₁ but are smaller than or equal to the true source voltage U^{o}₁. The deviation of the fuel cell from linear behaviour at I→0 sketched in FIG. 1 permits a greater tolerance as regards the source voltages of the elements of the hybrid source and is therefore even advantageous for the present invention.

In particular, problems associated with a possible overcharging of the battery can be avoided in a simple way if the battery in its fully charged state has a source voltage U₂^{max} which is about as large as the true source voltage U^{o}₁ of the fuel cell. For U₂^{max}=U^{o}₁ full charging of the battery will then only be reached asymptotically since the charging current tends to zero as U₂ approaches U^{o}₁. For U₂^{max}>U^{o}₁ full charging of the battery cannot be achieved any more with the arrangement shown in FIG. 4.

For vanishing load current (I=0) the charging current resulting with the above assumptions is
I₁=|I₂|=(U₁−U₂)/(R₁+R₂).

For a non-zero load current (I>0) the ratio of the internal resistances is the decisive factor determining the slopes of the I₁(I), I₂(I) straight lines.

For a 1:1 ratio both straight lines would have the same slope (0.5). The greater the ratio is the nearer the slope of the straight line of the energy source with the smaller internal resistance approaches the value 1, i.e. at higher load currents this energy source is the major contributor thereto. On the other hand, the straight line for the other energy source becomes ever flatter as the internal resistance increases, so that the current supplied by (or fed into) this source remains nearly constant (slope 0).

This will now be explained making reference to FIG. 7. First FIG. 7A. The higher source voltage of the fuel cell is responsible for the fact that at low load currents the fuel cell supplies the load current and also charges up the battery, i.e. I₂<0:
I₁=I+|I₂|.

At high load currents, however, the contribution of the battery soon dominates due to its smaller internal resistance: I₂≈I. High load currents lead to faster discharging of the battery. They should therefore only occur briefly and be followed by sufficiently long periods in which the battery can be charged up again,

If the battery discharges, i.e. I₂>0, over a long period, the source voltage of the battery gradually drops, which can lead to the situation shown in FIG. 7B: compared with FIG. 7A the load current region with I₂<0 is increased. At the same time the charging current |I₂| at the same load current is increased compared to FIG. 7A.

The hybrid arrangement described above can be used to advantage in many areas of important practical relevance.

For example, in situations where the current required by connected consumers can be divided up beforehand in the time domain, at least roughly, into regions with small (possibly vanishing) or high load. The fuel cell can then be so dimensioned that it can cover the small current required on its own and/or charge up the battery. The high load current needs, on the other hand, are covered mainly by battery current. The fuel cell can be used to particular advantage when longer periods of low (or vanishing) load currents alternate with shorter periods of comparatively high load currents.

It can also be used to advantage when the load current fluctuates about a temporal mean value. If this mean current consumption is predetermined, the hybrid system can be optimally designed for the application in question without the battery being overcharged or discharged too strongly.

As can be seen from FIG. 1, a strong increase in the load current needed, perhaps by many times, can, if a fuel cell is used on its own, lead to a complete collapse of its terminal voltage. For the time profile of the required load current I(t) sketched in FIG. 8A it can therefore happen that the terminal voltage U_{K} of the fuel cell completely collapses at load peaks. This is indicated by the dotted lines in the resulting U_{K}(t) profile in FIG. 8B.

If extreme load peaks occur, such a terminal voltage collapse could, however, also occur in the case of the hybrid source with one fuel cell 1 and one battery 21 shown in FIG. 4.

To handle such load peaks, particularly in applications where a load current which remains substantially constant over long periods is interrupted by short-lived load peaks, as shown in exemplary fashion in the upper diagram of FIG. 8, the embodiments of the hybrid energy source according to the present invention sketched in FIGS. 5 and 6 are preferred, wherein the battery 21 is replaced or supplemented by a capacitor 22.

By using a suitable capacitor 22 the effect of the load peaks on the terminal voltage can be reduced substantially, as indicated by the unbroken line profile in the lower diagram of FIG. 8. When load peaks occur, the capacitor 22, which in normal operation is charged up by the fuel cell (FIG. 5) and/or the battery (FIG. 6) contributes substantially to the current flow and thereby prevents too strong a decrease in the terminal voltage of the hybrid energy source. After the disappearance of each load peak the capacitor is charged up again by the fuel cell 1.

In addition to traditional capacitors, so-called supercaps (“super capacitors”) can, in particular, be used to advantage, which as a result of their high capacitance can cushion not only momentary load peaks but also longer high-load periods without the voltage of the hybrid energy source declining substantially.

If the source voltage of the fuel cell is greater than the source voltage of the battery when fully charged, a charging current still flows into the battery at low or vanishing load currents even when the battery is fully charged. This current can lead to overcharging of the battery and thus to a strongly reduced lifetime expectancy of the battery. To avoid this the current should be limited.

The exponential decrease in the fuel cell voltage with increasing current, which in this case is the charging current fed into the battery, can be exploited advantageously to limit the charging current, which is proportional to the voltage difference, if the system is so designed that
U₁<U₂≦U^{o}₁.

Here U^{o}₁ designates the true source voltage of the fuel cell, U₁ the “source voltage” obtained by extrapolation of the linear region for I→0 and U₂ the source voltage of the battery when fully charged.

Such a configuration of the hybrid source cannot always be realized, however. In a preferred manner overcharging of the battery can be avoided using the embodiment shown in FIG. 9, which is a modification of the embodiment sketched in FIG. 4. It is evident that a similar modification can also be performed for the embodiment represented in FIG. 6.

In the embodiment at least one connection between the fuel cell device 101 and the battery 121 comprises two branches a and b. In FIG. 9 these branches are on the plus pole side. They can, however, just as well be on the side of the minus poles.

The sole purpose of branch a is to allow the battery 121 to be charged up by the fuel cell device 101. To prevent overcharging a charge limiter 130 is provided. This charge limiter 130 may comprise a current and/or voltage limiter. The other branch b is connected to an output terminal: the contributions I₁>0, I₂>0 of the fuel cell device 101 and of the battery 121 to the load current I flow over this branch. A diode 140 is provided to prevent the battery 121 being charged UP (I₂<0) via branch b.

In a similar way an electrolysis current (I₁<0) into the fuel cell can be prevented in the described embodiments by providing a diode which is connected in series with the fuel cell and which permits only I₁≧0 and blocks for I₁<0. An alternative to the diode is an on/off switch which dissociates the fuel cell from the hybrid energy source as soon as I₁ and/or U₁ fall below specified threshold values.

An alternative method of controlling the charging current without recourse to a voltage converter is to monitor the time profile of the current I₂ as a function of the total current I and produce therefrom a continuous electronic record of the actual charged condition of the battery. Since I=I₁+I₂, two of the three quantities I, I₁, I₂ must be measured, which can e.g. be achieved by means of voltage measurements across two shunts (precision resistors). To prevent damage or destruction, an interrupter (electronically actuated switch), which decouples the fuel cell from the system as soon as I₁ falls below a certain threshold value, can also be provided in the connecting lines leading to the fuel cell.

The operational strategy of such a hybrid source can then be optimized in respect of the charged status of the battery, the lifetimes of battery and fuel cell device and the efficiency of the hybrid energy source.

A common feature of the embodiments described hitherto is that the terminal voltage of the hybrid energy source depends on various factors and that it fluctuates when there is a change in one or more of these factors: among the most important factors are the load current, the charged status of the battery, the operating conditions of the fuel cell, the capacitance of the capacitor.

A particularly preferred embodiment, with which a constant supply voltage can be achieved, is sketched in FIG. 10: a voltage regulator R is supplied therein, which coverts the terminal voltage U_{K} of the hybrid energy source into the desired output voltage U_{A}.

An example of such a regulator R is a PWM voltage regulator (PWM=pulse width modulation), whose mode of operation is indicated in FIGS. 11A and 11B. A PWM voltage regulator is a switch which is clocked at high frequency (typically in the kHz range, e.g. 20 kHz), which periodically switches the terminal voltage U_{K} on and off so that a square-wave voltage U_{A}(t) with amplitude U_{K} is generated from the variable terminal voltage U_{K}, which depends among other things on the charged status of the battery.

The (time-independent) output voltage U_{A} is the time-averaged mean of this square-wave voltage U_{A}(t) and is determined by the amplitude U_{K}, and the pulse width and clocking (period duration) of the PWM voltage regulator. The time averaging (smoothing) is effected by capacitors.

Control of the PWM voltage regulator is achieved by measuring the terminal voltage and/or the charged status permanently or at short intervals (e.g. via shunts) and adjusting the relevant settings of the PWM voltage regulator such as pulse width and/or clocking. This adjustment of the PWM voltage regulator to match changes in the terminal voltage can be accomplished almost in real time, so that an output voltage U_{A} sufficiently constant for most application areas can be provided.

In the example sketched in FIG. 11A the ratio between pulse width and period duration is 0.7, so the time-averaged mean value <U_{A}(t)>≡U_{A}=0.7 U_{K}. The output voltage of the hybrid energy source is thus reduced to 70% of the terminal voltage.

In the example sketched in FIG. 11B the ratio between pulse width and period duration is 0.2, so the output voltage of the hybrid energy source is reduced here to 20% of the terminal voltage.

Alternatives to the PWM device are linear regulators, voltage converters and Zener diodes. The advantage of the PWM device over these components lies in its improved efficiency, since losses occur only in connection with switching operations whereas with the other components cited above considerable ohmic losses occur especially when the output voltage decreases sharply compared with the terminal voltage.

Various details of the present invention have been explained in the description making reference to special preferred embodiments. However, there is no intention of restricting the scope of protection through the use of the embodiments sketched in the diagrams. That combinations of these preferred embodiments are possible is obvious and needs no special mention. The scope of protection is defined solely by the following claims.

1. Hybrid energy source, comprising a fuel cell device and an energy storing device, which are directly interconnected in parallel.

2. Hybrid energy source according to claim 1, wherein the energy storing device comprises a capacitor.

3. Hybrid energy source according to claim 1, wherein the energy storing device comprises a battery, which is connected to the fuel cell device in a homopolar arrangement.

4. Hybrid energy source according to claim 3, wherein at least one of the homopolar connections between the fuel cell device and the battery has two branches, wherein
the first branch is provided for the charging of the battery by the fuel cell device and has a charge limiter to limit the charging, and
the second branch is connected to an output terminal and contains a device to prevent charging of the battery via the second branch.

5. Hybrid energy source according to claim 1, with a device to prevent an electrolysis current through the fuel cell device.

6. Hybrid energy source according to claim 3, wherein die source voltage of the battery in the fully charged state differs by less than 10% from the source voltage of the fuel cell device.

7. Hybrid energy source according to claim 1, with a voltage regulator, which converts the terminal voltage of the hybrid energy source into a desired output voltage.

8. Hybrid energy source according to claim 7, wherein the voltage regulator comprises a PWM voltage regulator.

9. Hybrid energy source according to claim 2, wherein the energy storing device comprises a battery, which is connected to the fuel cell device in a homopolar arrangement.

10. Hybrid energy source according to claim 2, with a device to prevent an electrolysis current through the fuel cell device.

11. Hybrid energy source according to claim 3, with a device to prevent an electrolysis current through the fuel cell device.

12. Hybrid energy source according to claim 4, with a device to prevent an electrolysis current through the fuel cell device.

13. Hybrid energy source according to claim 4, wherein die source voltage of the battery in the fully charged state differs by less than 10% from the source voltage of the fuel cell device.

14. Hybrid energy source according to claim 5, wherein die source voltage of the battery in the fully charged state differs by less than 10% from the source voltage of the fuel cell device.

15. Hybrid energy source according to claim 2, with a voltage regulator, which converts the terminal voltage of the hybrid energy source into a desired output voltage.

16. Hybrid energy source according to claim 3, with a voltage regulator, which converts the terminal voltage of the hybrid energy source into a desired output voltage.

17. Hybrid energy source according to claim 4, with a voltage regulator, which converts the terminal voltage of the hybrid energy source into a desired output voltage.

18. Hybrid energy source according to claim 5, with a voltage regulator, which converts the terminal voltage of the hybrid energy source into a desired output voltage.

19. Hybrid energy source according to claim 6, with a voltage regulator, which converts the terminal voltage of the hybrid energy source into a desired output voltage.
